(19) United States
(12) Patent Application Publication
(10) Pub. No.: US 2020/0274781 A1
(43) Pub. Date: Aug. 27, 2020

(54) DEVICE FOR GENERATING VIEWS CORRESPONDING TO NETWORK DATA FLOW FROM SOURCE TO DESTINATION AND VICE VERSA AND A METHOD THEREOF

(71) Applicant: COLORTOKENS, INC., Santa Clara, CA (US)

(72) Inventors: Deepak Kushwaha, Bangalore (IN); Puneet Tutliani, Bangalore (IN)

(21) Appl. No.: 16/285,106

(22) Filed: Feb. 25, 2019

(51) Int. Cl. H04L 12/26

(52) U.S. Cl. CPC H04L 43/045; H04L 43/14; H04L 43/0876; H04L 43/062

(57) ABSTRACT

Disclosed herein are a method, a view generating computing device, and a non-transitory computer readable medium for generating plurality of views on a user interface in a big data environment, the views corresponding to data flows from a plurality of source devices to the plurality of destination devices and vice-versa, The method includes receiving data flows from each of the plurality of source devices and each of the plurality of destination devices, the data flows indicative of the flow of data between a source device and corresponding destination device; receiving a request from a user interface associated with a user device; generating, a source view, a destination view, and a differential view; rendering the source view, the destination view, and the differential view on the user interface, wherein the source view, the destination view, and the differential view are viewed concurrently in real time m response to the generating.

### FIELD OF THE INVENTION

The present disclosure relates generally to communication from source to destination and vice-versa, thereby generating session data flows. In particular, the present disclosure relates to a device and a method for generating views corresponding to communication session details that are associated with the generated session data flows from the source to the destination and vice-versa.

### BACKGROUND OF THE INVENTION

Network visibility products show session details or data flow information. These flows are captured from an inline firewall or a test access point (TAP) device. The TAP is a hardware device inserted at a specific point in the network to monitor data flows.

These firewalls are somewhere in middle of network path between the source (client) and destination (server), hence a single view of session is captured & presented. Similarly, the TAP device receives a copy of packet from a single point in the network, and therefore constrained to present a single view.

Further, an end-point agent based solution may collect information from end-points associated with both the source (client) and the destination (serve). However, only one view is presented to user interface to make it consistent with network visibility devices.

In view of the above problems associated with the state of the art solutions, there exists a need for a device and a method for providing concurrent views of the session details generated because of data flow between the source (client) and the destination (server). User may see one or more than one views together.

### SUMMARY OF THE INVENTION

Disclosed herein is a method for rendering plurality of views on a user is in a big data environment, the views corresponding to data flows from a plurality of source devices to the plurality of destination devices and vice-versa. The method includes receiving, by a view generating computing device, data flows from each of the plurality of source devices and each of the plurality of destination devices, the data flows indicative of the flow of data between a source device and corresponding destination device; receiving, by the view generating computing device, a request from a user interface associated with a user device, the request being associated with generation of the plurality of views on the user interface;

generating, by the view generating computing device, a source view, a destination view, and a differentials in response to receiving the request; rendering, by the view generating computing device, the source view, the destination view, and the differential view on the user interface, wherein the source view, the destination view, and the differential view are viewed concurrently in real time in response to the generating.

In another aspect of the present disclosure, a view generating computing device for rendering plurality of views on a user interface in a big data environment, the plurality of views corresponding to data flows from a plurality of source devices to a plurality of destination devices and vice-versa is disclosed. The device includes one or more hardware processors: a memory storing instructions that when executed by the one or hardware processors causes the one or more hardware processors to perform operations. The operations include receiving data flows from each of the plurality of source devices and each of the plurality of destination devices, the data flows indicative of the flow of data between a source device and corresponding destination device; receiving a request from a user device comprising user interface, the request is associated with generating of the views on the user interface; generating a source view, a destination view, and a differential view in response to receiving the request; rendering the source view, the destination view, and the differential view on the user interface, wherein the source view, the destination view, and the differential view are viewed concurrently in real time in response to the generating,

In yet another aspect of the present disclosure, a non-transitory computer readable storage medium is disclosed. The medium stores instructions that when executed by a view generating computing device for rendering plurality of views on a user interface in a big data environment, the plurality of views corresponding to data flows from a plurality of source devices to a plurality of destination devices and vice-versa, causes the view generating computing device to perform operations. The operations includes receiving data flows from each of the plurality of source devices and each of the plurality of destination devices, the data flows indicative of the flow of data between a source device and corresponding destination device; receiving a request from a user device comprising user interface, the request is associated with generating of the plurality of views on the user interface; generating a source view, a destination view, and a differential view in response to receiving the request; rendering the source view, the destination view, and the differential view on the user interface, wherein the source view, the destination view, and the differential view are viewed concurrently in real time in response to the generating.

These and other aspects of the embodiments herein will be better appreciated and understood when considered in conjunction with the following description and the accompanying drawings. It should he understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG, 1 illustrates big data environment implementing process of gener6ating views corresponding to network data flow among hosts;

FIG. 2 is a block diagram illustrating a view generating computing device consistent with implementations of the current subject matter;

FIGS. 3A-3C illustrates source view, destination view, and differential view in accordance with principles of the present disclosure.

FIG. 4 is a flowchart for illustrating a method for generating plurality of views on a user interface in the big data environment.

### DETAILED DESCRIPTION

Embodiments of techniques of for generating multiple views corresponding to network data flow from source and destination and vice-versa are described herein.

In the following description, numerous specific details are set forth to provide a thorough understanding of the embodiments. A person of ordinary skill in the relevant art will recognize, however, that the embodiments can he practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments, Thus, the appearances of these phrases in various places throughout this specification are not necessarily all referring to the same embodiment. Furthermore, the particular features, structures, or characteristics may be combined in any suitable manner in one or more embodiments.

The present disclosure illustrates an exemplary big data environment for implementing process of generating views corresponding to network data flow from source and destination. The views pertain to data flows from a plurality of source devices to the plurality of destination devices and vice-versa. Firstly, data flows from each of the plurality of source devices and each of the plurality of destination devices are received. The data flows are indicative of the flow of data between a source device and corresponding destination device and vice-versa. Thereafter, a request from a user interface associated with a user device is received followed by generation of a source view, a destination view, and, a differential view. Finally, the source view, the destination view, and the differential view are rendered on the user interface, wherein the source view, the destination view, and the differential view are viewed concurrently in real time in response to the generating,

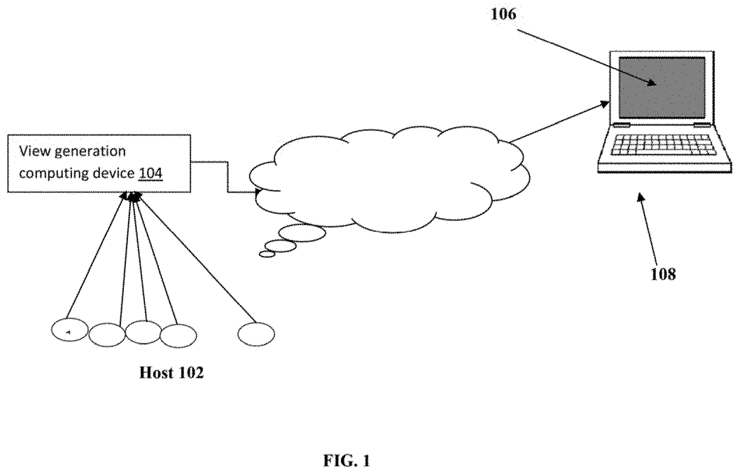

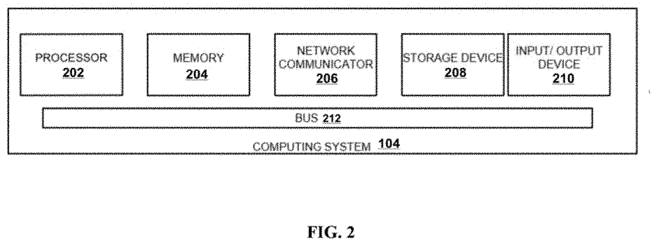

FIG. 1 illustrates a big data environment 100 implementing process of generating views corresponding to network data flow among, hosts 102-1, 102-2, . . . , 102-n, collectively referred to as 102. End point agents capture the data from host's point of view. At one instance for one flow, the hosts 102 could be either source or destination. End-point agents keep running on each of the hosts 102. Agents collect flows and send flow information to a view generating computing device 104 (as explained in detail in conjunction with FIG. 2).

Captured flows are periodically uploaded to the view generating computing device 104. The view generating computing device 104 stores data received from individual host 102, The view generating computing device 104 also marks the relationship between source & destination host for each flow. This process is performed by correlating flow's direction & IP addresses. For an outbound direction flow, source IP will be mapped to source host and the destination IP will be mapped to destination host. For inbound flow direction, destination IP will be mapped to destination host and source IP will be mapped to source host

For an outbound direction flow, source IP will be mapped to source host, which is also a flow reporting host, and the destination IP will be mapped to destination host. For inbound flow direction, destination IP will be mapped to destination host, which is a flow reporting host, and source IP will be mapped to source host.”

Thereafter, a request from a user interface 106 associated with a user device 108 is received followed by generation of a source view, a destination view, and, a differential view. The generation is performed by the view generating computing device 104. The view generating computing device 104 and the user device 108 are communicatively coupled to each other. Such coupling may be wired and wireless.

Finally, the view generating computing device 104 renders the source view, the destination view, and the, differential view on the user interface 106, wherein the source view, the destination view, and the differential view are viewed concurrently in real time in response to the generating. Source view is rendered from sender's point of view and the destination view is from receiver's point of view.

Displaying differential view is performed by comparing following attributes from source data and destination data that includes aggregate number of packets, aggregate bytes transferred, per packet difference—a) payload length, b) IP options, c) TCP options in case of TCP.

Admin or user sees flows from both sender's point of view, receiver's point of view. User can see differential information as well. These views dearly present information that flows are collected from both source (client) and destination (server). These views help user to infer behavioral correctness or anomaly between client & server interaction, which is not possible when providing a single view, e.g. fragmentation in the middle, UDP packet drops etc.

FIG. 2 is a block diagram illustrating a view generating computing device 104 consistent with implementations of the current subject matter. As shown in FIG. 2, the view generating computing device 104 can include a processor 202, a memory 204 (may be a big database store storing enormous amount of network flows), network communicator 206, a storage device 208, and input/output devices 210. The processor 202, the memory 204, network communicator 206, the storage device 208, and the input/output device 210 can be interconnected via a system bus 212. The processor 202 is capable of processing instructions for execution within the view generating computing device 104. Such executed instructions can implement one or more components of, for example, application A. In some example embodiments, the processor 202 can be a single-threaded processor. Alternately, the processor 202 can be a multi-threaded processor. The processor 202 is capable of processing instructions stored in the memory 204 and/or on the storage device 208 to display graphical information for a user interface provided via the input/output device 410.

The memory 204 is a computer readable medium such as volatile or non-volatile that stores information within the view generating computing device 104. The memory 204 can store instructions and/or other data associated with the processes disclosed herein. The storage device 208 is capable of providing persistent storage for the view generating computing device 104. The storage device 208 can be a hard disk device, an optical disk device, a tape device, or other suitable persistent storage means. The input/output device 210 provides input/output operations for the view generating computing device 104. In some example embodiments, the input/output device 210 includes a keyboard and/or pointing device. In various implementations, the input/output device 210 includes a display unit for displaying graphical user interfaces.

According to some example embodiments, the input/output device 210 can provide input/output operations for a network device. For example, the input/output device 210 can include Ethernet ports or other networking ports to communicate with one or more wired and/or wireless networks (e.g., a local area network (LAN), a wide area. network (WAN), the Internet).

In some example embodiments, the view generating computing device 104 can be used to execute various interactive computer software applications that can be used for organization, analysis and/or storage of data in various formats. Alternatively, the view generating computing device 104 can be used to execute any type of software applications. These applications can be used to perform various functionalities, e.g., planning functionalities e.g., generating, managing, editing of spreadsheet documents, word processing documents, and/or any other objects, etc.), computing functionalities, communications functionalities, etc. Upon activation within the applications, the functionalities can be used to generate the user interface provided via the input/output device 210. The user interface call e generated and presented to a user by the view generating computing device 104 (e.g., on a computer screen monitor, etc.),

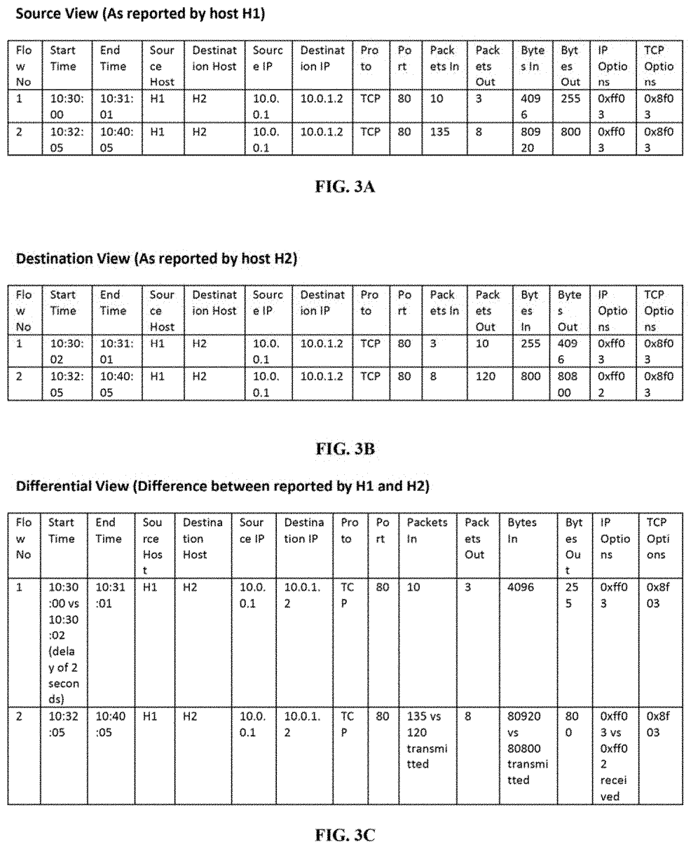

FIGS. 3A-3C. illustrates source view, destination view, and differential view in accordance with principles of the present disclosure.

In FIG. 3A, source view (sender point of view) is illustrated. In the source view, inbound data flow is compared against the outbound data flow with respect to the source (client). Inbound and outbound data flow are measured in terms of Bytes IN and Bytes OUT.

In source view, source host is flow reporting host, i.e. ingress (inbound flow) and egress (outbound flow) data flow characteristics are reported with respect to source host. In FIG. 3A, two flows have been illustrated, i.e. flow 1 and flow 2. Parameters associated with source view are as flows:
Flow No.—Indicates the sequence number of flow
Start time: Time at which the data flow starts from source host corresponding to flow number 1
End time: Time at which the data flow ends from source host. corresponding to flow number 1.
Source Host H1: host from which the data flow initiates
Destination host H2: Host at which the data flow terminates
Source IP: IP address associated with the source host H1.
Destination IP: IP address associated with the destination host H2
Port: Port associated with the data flow
Packets IN and packets OUT: corresponds to inbound flow and outbound flow associated the source host H1. Bytes IN and Bytes OUT: corresponds to inbound flow and outbound flow associated the source host H1 and measured in Bytes.

In FIG. 3B, destination view (receiver point of view) is illustrated. In the destination view, inbound data flow is compared against the outbound data flow with respect to the destination server). Inbound and outbound data flow are measured in terms of Bytes IN and. Bytes OUT.

In destination view, destination host is flow reporting host, i.e. ingress (inbound flow) and egress (outbound flow) data flow characteristics are reported with respect to the destination host.

In an exemplary embodiment, outbound flow (packets OUT) for source view is equal to inbound flow (packets IN) of the destination view. Further, inbound flow (packets IN) for source view is equal to outbound flow (packets OUT) of the destination view. However, outbound flow (packets OUT) for source view may not be equal to inbound flow (packets IN) of the destination view. Further, inbound flow (packets IN) for source view may not be equal to outbound flow (packets OUT) of the destination view. This may be because of packets drop during the course of transmission of the data packets, This equality and inequality is captured in differential view,

In FIG. 3C, differential view is illustrated. In the differential view, inbound data flow is compared against the outbound data flow with respect to one or both of the source and the destination, Inbound and outbound data flow are measured in terms of differential between Bytes IN and Bytes OUT, For example, Packets IN source view is 120 and packets OUT in destination view is 135. Therefore, 15 packets have been lost during transmission from the server to the client.

For the purpose of illustration, single source host Hi and a single destination host H2 have been illustrated, however, a plurality of source hosts and a plurality of destination hosts are within the scope of the present disclosure.

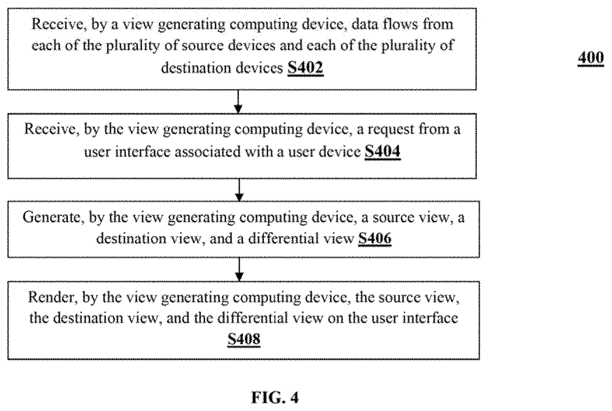

FIG. 4 is a flowchart 400 illustrating a method for rendering plurality of views on a user interface in a big data environment. The views correspond to data flows from a plurality of source devices to the plurality of destination devices and vice-versa.

At step S402, receive, by the view generating computing device 104, data flows from each of the plurality of source devices and each of the plurality of destination devices, the data flows indicative of the flow of data between a source device and corresponding destination device;

At step S404, receive, by the view generating computing device, a request from a user interface associated with a user device, the request is regarding the generation of the plurality of views with regard to the network flows

At step S406, generate, by the view generating computing device, a source view, a destination view, and a differential view;

At step S408, render, by the view generating computing device, the, source view, the destination view, and the differential view on the user interface, wherein the source view, the destination view, and the differential view are viewed concurrently in real time in response to the generating.

Some embodiments may include the above-described methods being written as one or more software components. Client may use these components, and the functionality associated with each, server, distributed, or peer computer systems. These components may be written in a computer language corresponding to one or more programming languages such as functional, declarative, procedural, object-oriented, lower level languages and the like. They may be linked to other components via various application-programming interfaces and then compiled into one complete application for a server or a client Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices, Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal, The term “machine-readable signal,” refers to any signal used to provide machine instructions and/or data to a programmable processor, The machine-readable medium can store such machine instructions non-transitory, such as for example as would a non-transient solid-state memory or a magnetic hard drive or any equivalent storage medium, The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail,

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described. in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description, Rather, the scope is to be determined by the following claims, which are to be interpreted in accordance with established doctrines of claim construction.

What is claimed is:

1. A method for rendering plurality of views on a user interface in a big data environment, the views corresponding to data flows from a plurality of source devices to the plurality of destination devices and vice-versa, the method comprising;
receiving, by a view generating computing device, data flows from each of the plurality of source devices and each of the plurality of destination devices, the data flows indicative of the flow of data between a source device and corresponding destination device;
receiving, by the view generating computing device, a request from a user interface associated with a user device, the request being associated with generation of the plurality of views on the user interface;
generating by the view generating computing device, a source view, a destination view, and a differential view in response to receiving the request;
rendering, the view generating computing device, the source view the destination view, and the differential view on the user interface, wherein the source view, the destination view, and the differential view are viewed concurrently in real time in response to the generating.

2. The method as claimed in claim 1, wherein in a source view, the flow of data is between a source device and a plurality of destination devices.

3. The method as claimed in claim 1, wherein in a destination view, the flow of data is between a destination device and a plurality of source devices.

4. The Method as claimed in claim 1, wherein the source view is illustrative of ingress and egress data flow statistics associated with the source device.

5. The method as claimed in claim 1, wherein the destination view is illustrative of ingress and egress data flow statistics associated with the destination device.

6. The method as claimed in claim 1, wherein the differential view is generated by comparing a plurality of parameters associated with the source device and the destination device.

7. The method as claimed in claim 6, wherein the plurality of parameters comprise at least one of an aggregate number of packets, aggregate bytes transferred, or per packet difference with respect is at least one of a payload length and internet protocol/TCP options.

8. The method as claimed in claim 1, wherein one or more of the source view, the destination view, and the differential view are viewable concurrently on the user interface.

9. A view generating computing device for rendering a plurality of views on a user interface in a big data environment, the plurality of views corresponding to data flows from a plurality of source devices to a plurality of destination devices and vice-versa, the device comprising;
one or more hardware processors;
a memory storing instructions that when executed by the one or more hardware processors causes the one or more hardware processors to perform operations comprising;
receiving data flows from each of the plurality of source devices and each of the plurality of destination devices, the data flows indicative of the flow of data between a source device and corresponding destination device;
receiving a request from a user device comprising user interface, the request is associated with generating of the plurality of views on the user interface;
generating a source view, a destination view, and a differential view in response to receiving the request;
rendering the source view, the destination view, and the differential view on the user interface, wherein the source view, the destination view, and the differential view are viewed concurrently in real time in response to the generating.

10. The device as claimed in claim 9, wherein in a source view, the flow of data is between a source device and a plurality of destination devices.

11. The device as claimed in claim 9. wherein in a destination view, the flow of data is between a destination device and a plurality of source devices.

12. The device as claimed in claim 9, wherein the source view is illustrative of ingress and egress data flow statistics associated with the source device.

13. The device as claimed in claim 9, wherein the destination view is illustrative of ingress and egress data flow statistics associated with the destination device.

14. The device as claimed in claim 9, wherein the differential view is generated by comparing a plurality of parameters associated with the source device and the destination device.

15. The device as claimed in claim 14, wherein the plurality of parameters comprise at least one of an aggregate number of packets, aggregate bytes transferred, or per packet difference with respect to at least one of a payload length and internet protocol/TCP options.

16. The device as claimed in claim 9, wherein one or more of the source view, the destination view, and the differential view are viewable concurrently on the user interface.

17. A non-transitory computer readable storage medium storing instructions thereon that when executed by a view generating computing device for rendering plurality of views on a user interface in a big data environment, the plurality of views corresponding to data flows from a plurality of source devices to a plurality of destination devices and vice-versa, causes the view generating computing device to perform operations comprising:
receiving data flows from each of the plurality of source devices and each of the plurality of destination devices, the data flows indicative of the flow of data between a source device and corresponding destination device;
receiving a request from a user device comprising user interface the request is associated with generating of the plurality of views on the user interface;
generating a source view, a destination view, and a differential view in response to receiving the request;
rendering the source view, the destination dew, and the differential view on the user interface, wherein the source view, the destination view, and the differential view are viewed concurrently in real time in response to the generating.

18. The medium as claimed in claim 17, wherein in a source view, the flow of data is between a source device and a plurality of destination devices.

19. The medium as claimed in claim 17, wherein in a destination view, the flow of data is between a destination device and a plurality of source. devices.

20. The medium as claimed in claim 17, wherein the source view is illustrative of ingress and egress data flow statistics associated with the source device.

21. The medium as claimed in claim 17, herein the destination view is illustrative of ingress and egress data flow statistics associated with the destination device.

22. The medium as claimed in claim 17, wherein the differential view is generated by comparing a plurality of parameters associated with the source device and the destination device.

23. The medium as claimed in claim 22, wherein the plurality of parameters comprise at least one of an aggregate number of packets, aggregate bytes transferred, or per packet difference with respect to at least one of a payload length and internet protocol/TCP options.

24. The medium as claimed in claim 17, herein one or more of the source view, the destination view, and the differential view are viewable concurrently on the user interface.
